(19) United States
(12) Patent Application Publication
(10) Pub. No.: US 2007/0022720 A1
(43) Pub. Date: Feb. 1, 2007

(54) Cleaner for cooling system screen of outdoor power equipment unit

(75) Inventor: Richard J. Guertin, Mounds View, MN (US)

Correspondence Address: James W. Miller, Esq.;Suite 1960, Rand Tower, 527 Marquette Avenue, Minneapolis, MN, 55402, US

(73) Assignee: The Toro Company

(21) Appl. No.: 11/190,365

(22) Filed: Jul. 27, 2005

(51) Int. Cl. B01D 46/00

(52) U.S. Cl. 55/289

(57) ABSTRACT

A screen cleaner for an outdoor power equipment unit comprises a cleaning member pivotally mounted adjacent a screen in the cooling system for the prime mover of the outdoor power equipment unit. A reversible powered actuator oscillates the screen cleaner back and forth over the screen to momentarily block air flow through the portion of the screen covered by the cleaning member. Any airborne debris such as grass clippings adhering to the portion of the screen covered by the cleaning member will fall off the screen during the time the air flow is momentarily blocked by the cleaning member. The screen is slanted inwardly as it extends downwardly to enhance the ability of the debris to fall off the screen without sticking to lower portions of the screen.

### TECHNICAL FIELD

This invention relates to an outdoor power equipment unit, such as a riding lawn mower, powered by a prime mover that is cooled by an air flow that passes through a screen of a cooling system. More particularly, this invention relates to outdoor power equipment units in which fouling or clogging of the cooling system screen with airborne debris is a problem.

### BACKGROUND OF THE INVENTION

Outdoor power equipment units are known that perform various types of ground or turf working or grooming operations. For example, commercial lawn mowers are known that comprise large riding vehicles carrying a plurality of cutting units or cutting blades for mowing a wide swath of grass. Inherently, the mowing operations performed by such mowers create a fair amount of airborne debris in the form of small airborne grass clippings and the like. This is particularly true when, as is often the case, the grass clippings are being discharged onto the ground rather than being bagged. For large commercial mowers that mow large areas of ground, such as the fairways on a golf course, the grass clippings are usually deposited back onto the ground.

Commercial lawn mowers of the type described above are normally powered by a prime mover such as an internal combustion engine or a diesel engine. A cooling system is provided for cooling the prime mover. The cooling system includes a screen through which an air flow passes. Unfortunately, the airborne debris generated by the mower in the form of airborne grass clippings tends to stick on the suction side of the screen and clog or foul the screen. If the cooling system screen becomes too clogged with debris, the air flow is diminished to the point where overheating and possible damage to the prime mover are possible.

Consequently, the operator of this type of outdoor power equipment unit must ensure that the cooling system screen remains relatively free of debris. One way to do this is to periodically stop and inspect the screen. If the screen is overly fouled, the operator must then take the time to brush or wash the screen free of debris. Since the screen is normally protected behind a grille, such a manual cleaning operation is quite difficult or might require removal of the grille to have access to the screen. Such a manual inspection and cleaning procedure is so onerous that most operators would not take the time to do it making such a procedure impractical at best.

Certain outdoor power equipment units, such as agricultural harvesters and combines, include powered cleaners for keeping the cooling system screen free of debris. However, the screens used in such units are often large rotary screens in which rotary cleaners revolve to help clean the screen. The cooling system screens used in commercial lawn mowers are usually flat and more in the nature and size of an automotive style radiator. Thus, the larger and more complex screens and cleaners used in harvesters and combines are not well suited for cleaning the smaller and flatter screens found in such mowers.

Accordingly, there is a need in the outdoor power equipment art for a simple and effective cleaner for keeping a cooling system screen free of airborne debris.

### SUMMARY OF THE INVENTION

One aspect of this invention relates to a cleaner for a screen in a cooling system of an outdoor power equipment unit. The cleaner comprises a cleaning member mounted for pivotal motion adjacent the screen. The cleaning member is sized to cover a portion of the screen while leaving uncovered other portions of the screen. A powered actuator oscillates the cleaning member back and forth over the screen during operation of the outdoor power equipment unit such that the portion of the screen covered by the cleaning member varies during movement of the cleaning member as the cleaning member traverses over the screen. Airborne debris drops off the portion of the screen covered by the cleaning member to help keep the screen from becoming covered with airborne debris.

Another aspect of this invention relates to an outdoor power equipment unit which comprises a movable frame carrying an implement for performing a ground or turf working or grooming operation. A prime mover is carried on the frame. A cooling system is carried on the frame for cooling the prime mover. The cooling system has a screen through which an air flow passes. The screen is slanted inwardly relative to the frame as the screen extends downwardly from top to bottom such that any airborne debris clinging to the screen can fall off the screen free of underlying portions of the screen over any portions of the screen through which air flow is momentarily blocked. A movable cleaning member momentarily blocks air flow through different and varying portions of the screen during operation of the outdoor power equipment unit.

### BRIEF DESCRIPTION OF THE DRAWINGS

This invention will be described more completely in the following Detailed Description, when taken in conjunction with the following drawings, in which like reference numerals refer to like elements throughout.

FIG. 1 is a perspective view of an outdoor power equipment unit, such as a riding lawn mower, that includes a screen cleaner according to this invention;

FIG. 2 is a perspective view of the exterior of the grille and screen used in the outdoor power equipment unit of FIG. 1;

FIG. 3 is a perspective view of the interior of the grille and screen used in the outdoor power equipment unit of FIG. 1, particularly illustrating a first embodiment of a screen cleaner according to this invention with the screen cleaner being shown in a first cleaning position relative to the screen;

FIG. 4 is a perspective view similar to FIG. 3, but particularly illustrating the screen cleaner in a second cleaning position relative to the screen;

FIG. 5 is a perspective view of the screen cleaner shown in FIG. 3, particularly illustrating the pivotal mounting of the cleaning plate of the screen cleaner adjacent the inside face of the screen and the pivotal mounting of the linear actuator that oscillates the screen cleaner;

FIG. 6 is a perspective view of the screen cleaner shown in FIG. 3, particularly illustrating the connection between the cleaning plate and the linear actuator;

FIG. 7 is a perspective view of a radial outer end of the cleaning plate of the screen cleaner shown in FIG. 3, particularly illustrating the guide between the radial outer end of the cleaning plate and the frame of the outdoor power equipment unit as well as the spacing of the cleaning plate of the screen cleaner a short distance away from the screen;

FIG. 8 is a plan view of the radial outer end of the cleaning plate as shown in FIG. 7, further illustrating the guide shown in FIG. 7;

FIG. 9 is a cross-sectional view taken along lines 9-9 of FIG. 8, further illustrating the guide shown in FIG. 7 and the inward slant of the screen as the screen extends downwardly;

FIG. 10 is a perspective view of the interior of the grille and screen used in the outdoor power equipment unit of FIG. 1, particularly illustrating a second embodiment of a screen cleaner according to this invention with the screen cleaner being shown in a first cleaning position relative to the screen;

FIG. 11 is a perspective view of the screen cleaner shown in FIG. 10, particularly illustrating the pivotal mounting of the cleaning plate of the screen cleaner adjacent the inside face of the screen as well as the connection between the cleaning plate and the shaft of a rotary motor for oscillating the cleaning plate relative to the screen;

FIG. 12 is a perspective view of the interior of the grille used in conjunction with either of the screen cleaners shown in FIG. 1 or 10, particularly illustrating a variation in grille configuration and substantially solid side and bottom air flow baffles that may be used to improve performance; and

FIG. 13 is a perspective view of one side of the screen that is part of the cooling system of the outdoor power equipment unit, particularly illustrating how the side baffles attach to the side edges of the screen.

### DETAILED DESCRIPTION

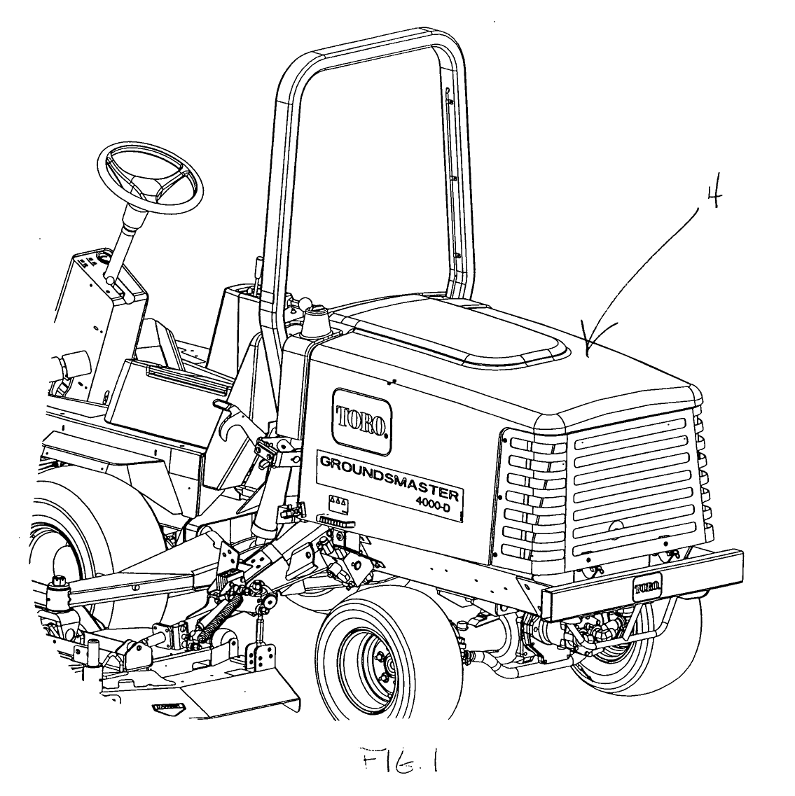

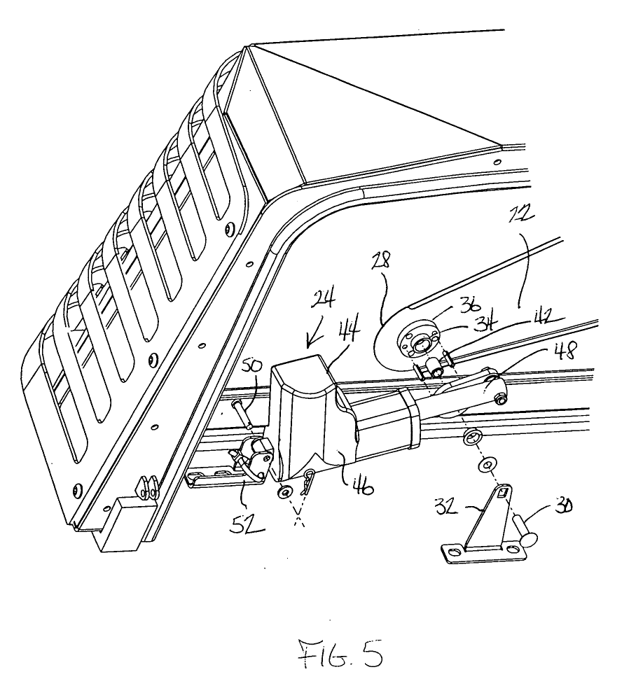

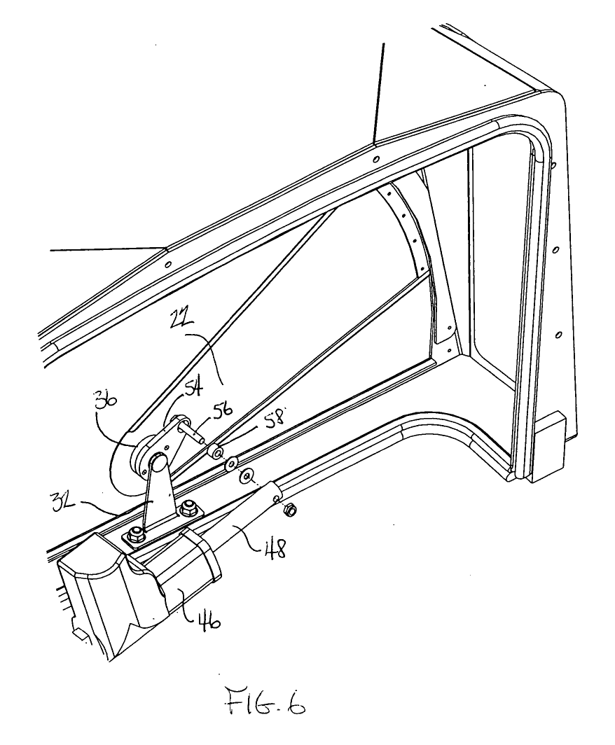

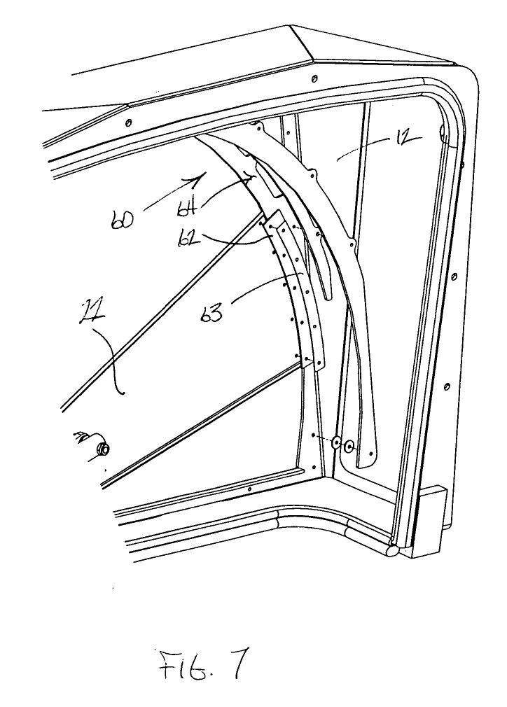

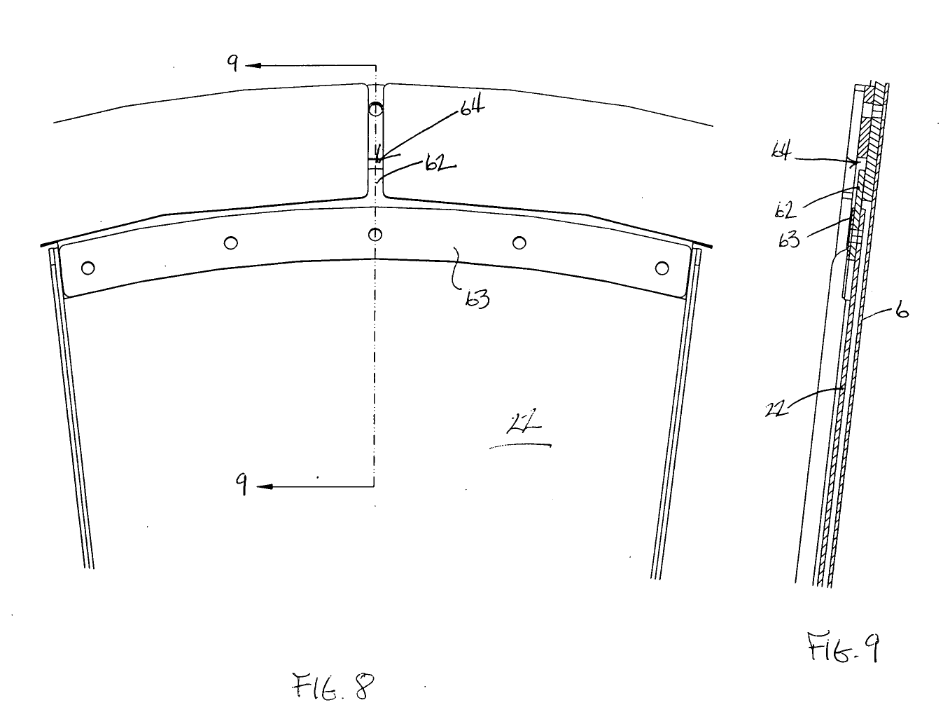

This invention relates to a screen cleaner for an outdoor power equipment unit. One embodiment of a screen cleaner according to this invention is illustrated generally as 2 in FIGS. 1-9. One embodiment of an outdoor power equipment unit that can utilize screen cleaner 2 is the riding lawn mower illustrated generally as 4 in FIG. 1. Screen cleaner 2 may be used with other types of outdoor power equipment units that perform ground or turf working or grooming operations other than mowing.

Mower 4 has a cooling system that includes a relatively flat or planar screen 6. The screen 6 is protected by an exterior grille 8. Screen 6 and grille 8 are shown in FIG. 1 at the rear of mower 4. However, screen 6 and grille 8 could be positioned at different places on mower 4. An air flow passes through screen 6 and grille 8 during the operation of the cooling system to help cool a prime mover (not shown) housed inside a cover or hood of mower 4.

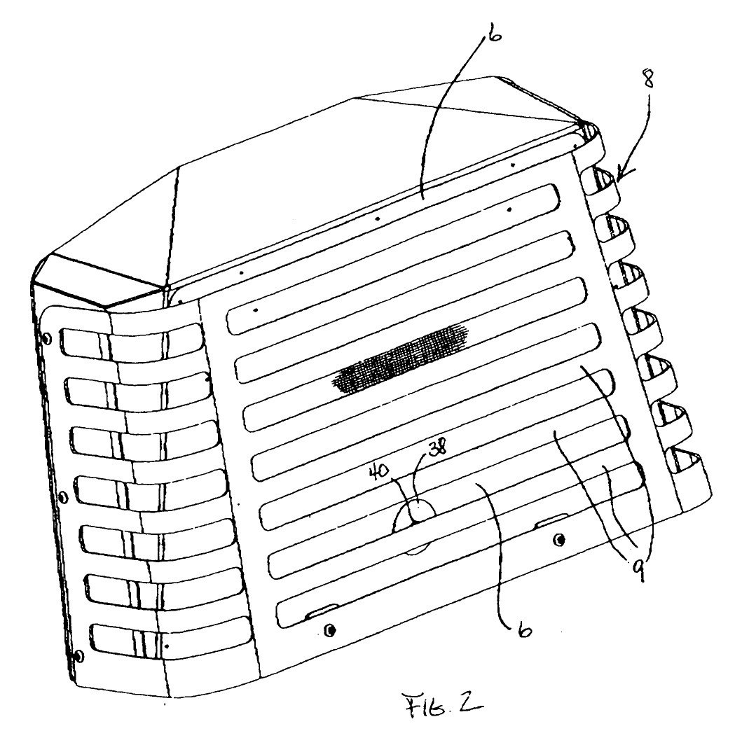

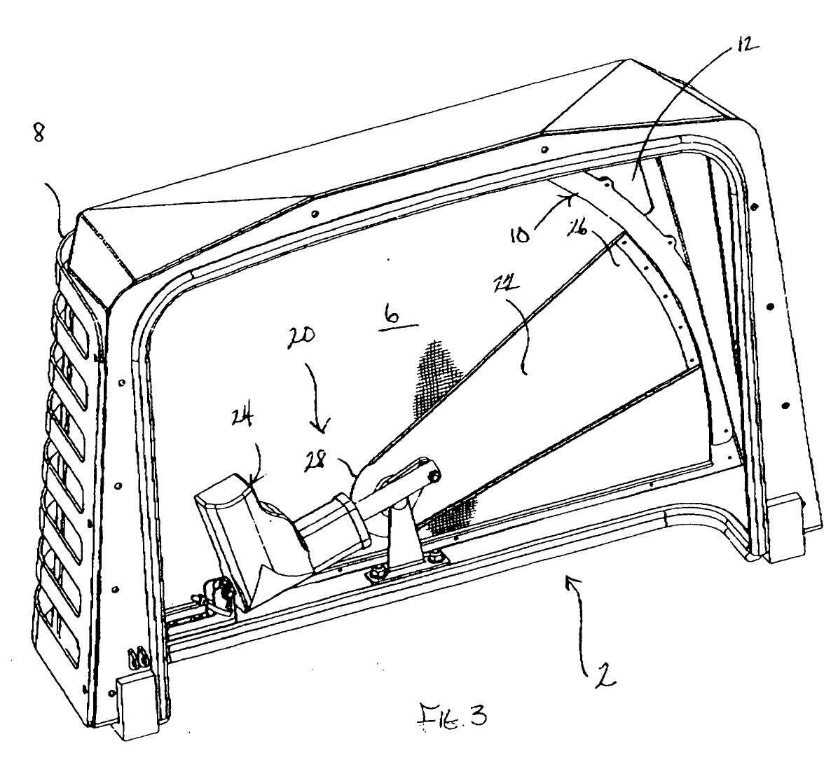

Referring now to FIG. 2, screen 6 is a relatively flat or planar screen that is bolted or screwed to the frame of mower 4. As shown in FIG. 3, screen 6 covers a main air ingress opening 10 in the rear end of mower 4 with main opening 10 having a semicircular shape. Screen 6 also has left and right upper corner portions that extend over and cover smaller auxiliary air ingress openings 12 situated above and on either side of main opening 10. FIG. 3 illustrates a portion of one such auxiliary opening 12 above one side of main opening 10.

Grille 8 surrounds and protects the exterior side of screen 6. Grille 8 comprises a plurality of spaced bars 9 and the opposite sides of grille 8 are bent back in a U-shape to allow grille 8 to be secured to opposite sides of the rear end of mower 4. When in place, grille 8 protects screen 6 and prevents screen 6 from being damaged by inadvertent contact with external objects. The shapes of both grille 8 and screen 6 can vary from that shown herein, though it is preferred that a relatively flat, planar screen be used covering an air ingress opening in mower 4.

A first embodiment of a screen cleaner 20 according to this invention is illustrated in FIGS. 1-9. Screen cleaner 20 comprises two major components:
a cleaning member 22 pivotally mounted adjacent the inside face of screen 6; and
a powered actuator 24 for oscillating cleaning member 22 back and forth over screen 6.

Cleaning member 22 is preferably in the form of a relatively thin plate though cleaning member 22 could have other forms. Cleaning member 22 is sized to have an area that is significantly less than the open area of screen 22 covering main opening 10. As cleaning member 22 is oscillated back and forth over screen 6, it momentarily blocks air flow through screen 6 over the portion of screen 6 covered by cleaning member 22. This induces airborne debris on the covered portion of screen 6 to fall off screen 6 and down onto the ground. This will be explained in more detail hereafter.

Cleaning member 22 has a pie-shaped configuration with a wider radial outer end 26 and a thinner radial inner end 28. Inner end 28 of cleaning member 22 is pivotally supported on a fixed pivot shaft 30 carried on a support bracket 32 on the frame of mower 4. Pivot shaft 30 passes through a hub 34 contained on a collar 36 that is fixed to the rear face of cleaning member 22, through cleaning member 22 itself, through an opening (not shown) in screen 6, and finally through a washer 38 carried on the outside face of screen 6. A nut 40 clamps pivot shaft 30 in place against washer 38.

Thus, cleaning member 22 is pivotally supported on pivot shaft 30. One end of pivot shaft 30 is carried on support bracket 32. The other end of pivot shaft 30 is clamped to screen 6 as noted above, though this end could also be supported on a separate bracket on the frame of mower 4 similar to support bracket 32. A bushing 42 around pivot shaft 30 allows cleaning member 22 to smoothly pivot back and forth on pivot shaft 30.

Powered actuator 24 is an electrically powered linear actuator 44 having an actuator housing 46 and an actuator rod 48 that can be extended from or retracted within actuator housing 46. Actuator housing 46 of linear actuator 44 is pivotally connected to the frame of mower 4 adjacent and behind cleaning member 22 by a pivot pin 50 passing through a mounting bracket 52. Cleaning member 22 has a connecting link 54 fixed to collar 36 on cleaning member 22 by a pair of fasteners 55. The outer end of connecting link 54 is pivotally secured to the outer end of actuator rod 48 of linear actuator 44 by a pivot pin 56. A second bushing 58 between pivot pin 56 and connecting link 54 allows smooth pivoting motion of connecting link 54 on pivot pin 56.

The frame of mower 4 includes a guide 60 for outer end 26 of cleaning member 22. Guide 60 includes a guide lip 62 that is clamped to cleaning member 22 by a backing plate 63. When in place, guide lip 62 forms the radial outer edge of cleaning member 22. Preferably, guide lip 62 is formed of a low friction, plastic material.

Guide 60 further comprises an arcuate guide channel 64 on the radial inner edge of that part of the frame of mower 4 that forms main opening 10. When cleaning member 22 is installed in mower 4, guide lip 62 on cleaning member 22 is received in guide channel 64. When guide lip 62 is received in guide channel 64, cleaning member 22 is closely adjacent to screen 6 but is spaced slightly to the rear of screen 6. Thus, cleaning member 22 and screen 6 preferably do not directly contact one another and thus cannot scratch or damage one another as cleaning member 22 moves relative to screen 6. At least some portion of guide lip 62 is always received within guide channel 64 over the entire range of motion of cleaning member 22, i.e. guide lip 62 never completely moves out of guide channel 64.

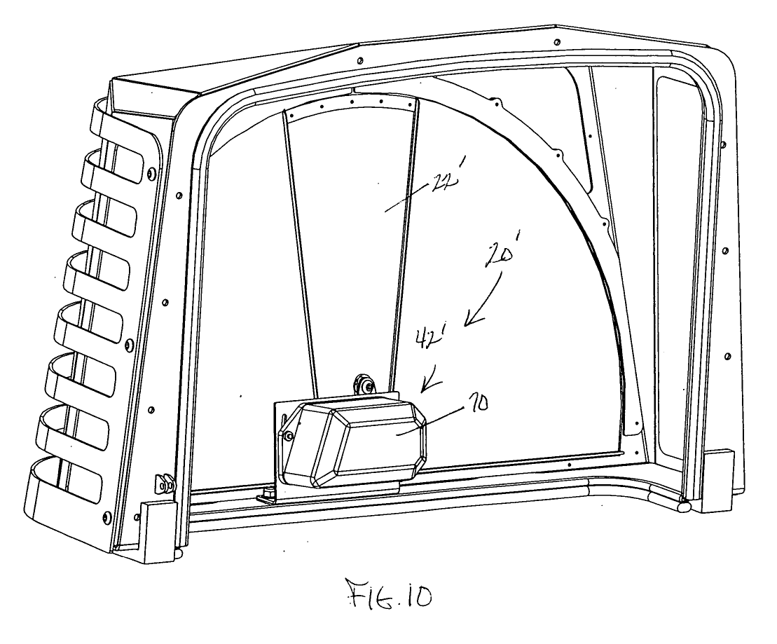

Screen 6 is slanted inwardly as it extends downwardly from top to bottom as best shown in FIG. 9. Accordingly, upper portions of screen 6 do not overlie lower portions of screen 6 but instead have free space beneath them. Thus, if a piece of debris is stuck to an upper portion of screen 6 but becomes dislodged therefrom, such a piece of debris is free to fall under the influence of gravity down onto the ground without striking or hitting a lower portion of screen 6. In this regard, a substantially open space is provided in mower 4 between the lower edge of screen 6 and the ground to allow debris to fall off screen 6 and down onto the ground.

Screen 6 is inclined at an angle to the vertical by inclining the portion of the frame of mower 4 against which screen 6 is mounted. Cleaning member 22 is similarly inclined by having support bracket 32 inclined at a mating angle relative to screen 6 when support bracket 32 is installed on the frame of mower 4. Linear actuator 44 is similarly mounted at an angle to correspond to the angle of cleaning member 22.

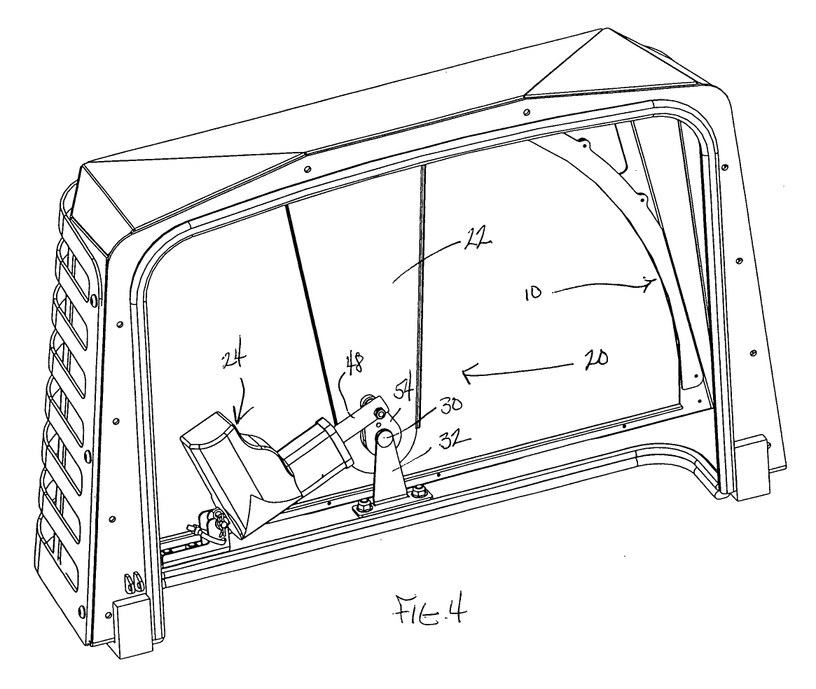

A suitable control circuit (not shown) on mower 4 is provided for causing linear actuator 44 to first extend and then retract actuator rod 48 in a continuous or intermittent fashion during operation of mower 4. This causes cleaning member 22 to oscillate back and forth relative to screen 6 as shown by arrow A in FIGS. 3 and 4. FIG. 3 shows actuator rod 48 almost fully extended with cleaning member 22 having swung over almost to the end of its arc of oscillation. FIG. 4 shows actuator rod 48 somewhat retracted with cleaning member 22 having swung to a midpoint of its arc of oscillation. Cleaning member 22 progressively oscillates through approximately 180° back and forth over substantially the entire open area of semicircular main opening 10.

As cleaning member 22 oscillates back and forth over screen 6, cleaning member 22 momentarily blocks air flow through that portion of screen 6 covered by cleaning member 22. Any debris that might have been sucked up against that portion of screen 6 will tend to fall off when the suction is removed from that portion of screen 6 simply by virtue of blocking the air flow in that portion of the screen. This tendency to fall off screen 6 is enhanced by the inward slant or inclination of screen 6 as it extends from top to bottom though such inclination is optional, i.e. screen 6 could be vertical. As cleaning member 22 oscillates back and forth, the portion of screen 6 in which debris falls of screen 6 progressively moves with cleaning member 22 so that the entire area of screen 6 covering main opening 10 is eventually affected. Since cleaning member 22 makes many consecutive passes back and forth over screen 6 during the operation of mower 4, screen 6 is kept substantially free and clear of airborne debris, such as grass clippings, to prevent screen 6 from becoming clogged and the cooling system for mower 4 from malfunctioning.

The portions of screen 6 covering auxiliary openings 12 are not reached or covered by cleaning member 22. Such auxiliary openings 12 help maximize the amount of open area of screen 6 for the cross-sectional area of the rear end of mower 4 covered by screen 6, but openings 12 could be deleted if desired and screen 6 could be shaped just to cover main opening 10. However, the portions of screen 6 that cover auxiliary openings 12 are less affected by being clogged with airborne debris since they are higher than the portion of screen 6 covering main opening 10 and tend not to be fouled by such debris to the same extent. Moreover, the portions of screen 6 that cover auxiliary openings 12 are easy to reach and clean by hand should they become fouled since they are at the top and sides of screen 6.

Screen cleaner 20 of this invention is very effective in cleaning a relatively flat or planar screen 6. Screen cleaner 20 is also simple, durable and cost effective. With screen cleaner 20 installed on mower 4, the prime mover of mower 4 will be much less likely to overheat even when significant airborne debris is present. Screen cleaner 20 causes such debris to fall off screen 6 of the cooling system and permits such debris to fall down onto the ground.

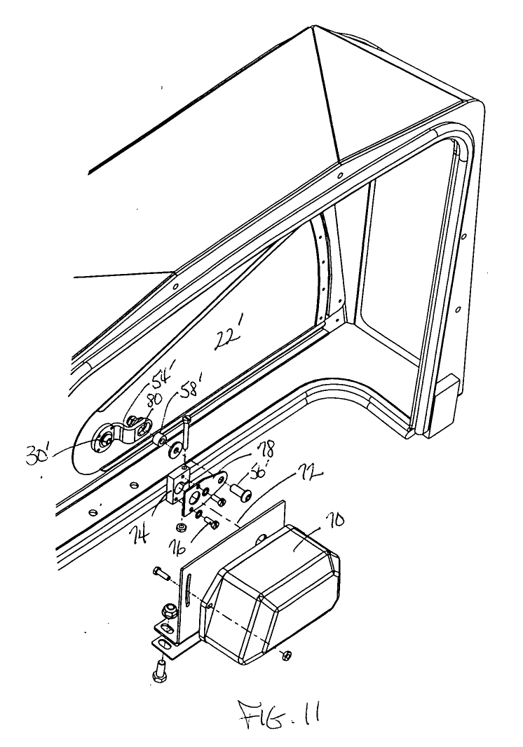

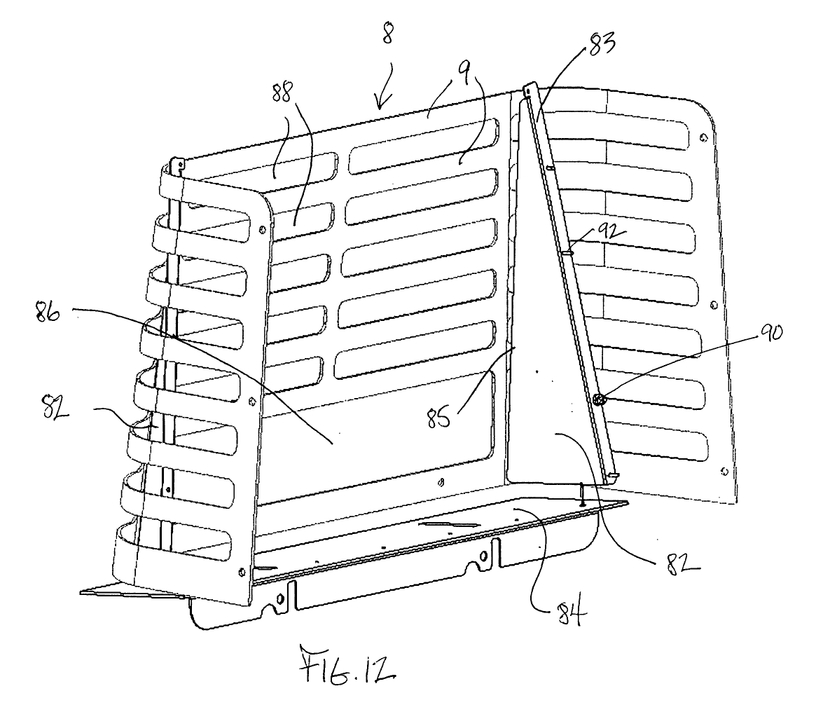

A second embodiment of a screen cleaner according to this invention is shown in FIGS. 10 and 11. In this embodiment, components will be marked with the same reference numbers as used for the same or similar components of the first embodiment except that a prime designation will be added to the number, e.g. screen cleaner 20′ instead of screen cleaner 20.

The primary difference between the two embodiments is the use of a different powered actuator 24′. In the second embodiment of FIGS. 10 and 11, powered actuator 24′ comprises a reversible, rotary electric motor 70 having an outwardly extending motor shaft diagrammatically represented as 72 in FIG. 11. Motor shaft 72 is clamped to a pillow block 74 that is secured by fasteners 76 to a pivot arm 78. Motor shaft 72 carries pivot arm 78 with it as motor shaft 72 rotates. Oscillation of pivot arm 78 is effected by changing the direction of rotation of motor shaft 72. Namely, motor shaft 72 is rotated 180° first in one direction, then reverses to rotate 180° in the opposite direction, and then repeats the cycle.

The outer end of pivot arm 78 is pivotally coupled to a connecting link 54′ on collar 36′ on the rear side of cleaning member 22′. The connection is accomplished by a pivot pin 56′ that passes through a bushing 58′ received in an elongated slot 80 in the radially outer end of connecting link 54′. Cleaning member 22′ is pivotally mounted on screen 6′ by a pivot shaft 30′ that is entirely supported on screen 6′, support bracket 32 having been deleted. Thus, as pivot arm 78 is oscillated, so too is connecting link 54′ and cleaning member 22′. Thus, screen cleaner 20′ of the second embodiment will work identically to screen cleaner 20 described in the first embodiment, but is simply powered by a different type of powered actuator.

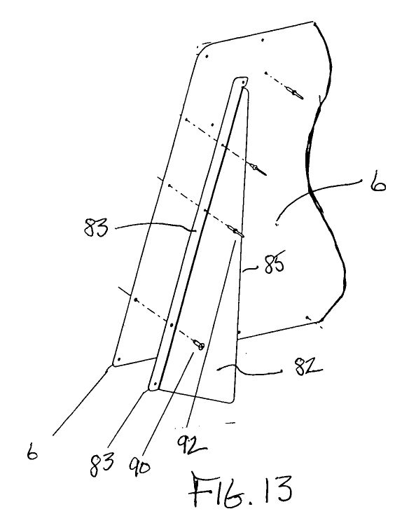

Referring now to FIGS. 12 and 13, a triangular air flow baffle 82 may optionally be located inside of each side of grille 8 where each side of grille 8 is bent to form the U-shape thereof. Each baffle 82 is generally identically shaped and placed. Each baffle 82 is smaller on the top and larger on the bottom gradually increasing in width as one proceeds from the top to the bottom thereof.

As shown most clearly in FIG. 13, each baffle 82 includes a mounting flange 83 along one side thereof which is adapted to lie along one of the side edges of screen 6. A plurality of fasteners, such as screw 90 and rivets 92, pass through mounting flange 83 to mount baffle 82 to the side edge of screen 6. The other baffle 82 is similarly mounted to the other side edge of screen 6. When so mounted, baffle 82 also is inwardly angled relative to the side edge of screen 6 to fit within the curve of one of the bends in the U-shape of grille 8. As shown in FIG. 12, the front edge 85 of baffle 82 will lie vertically along and adjacent one side of the central rear face of grille 8.

Baffles 82 help insure that air flowing around grille 8 as mower 4 moves forwardly is forced to flow around side baffles 82 to pass through screen 6. Rearwardly flowing air is blocked by the baffles 82 from being sucked at an angle through the sides of screen 6, but has to pass around the sides of baffles 82 and then pass through screen 6 primarily through the rear face of grille 8. This orients the incoming air flow to be generally perpendicular to screen 6. Accordingly, performance of screen cleaner 20 is enhanced.

Another optional performance enhancing improvement shown in FIG. 12 is the use of a bottom air flow floor or baffle 84. Such a baffle 84 may be used to cover or block the bottom and rear of grille 8. This prevents hot engine compartment air from being sucked up through the bottom and through screen 6. Incoming air is also forced around bottom baffle 84 and has to approach screen 6 generally perpendicularly similarly to what occurs with respect to side baffles 82. Again, system performance is enhanced with the presence of bottom baffle 84, though both side baffles 82 and bottom baffle 84 can be left off either partially or wholly if so desired.

Finally, the lowermost bar 9 in the central rear face of grille 8 may be removed from grille 8 so that the bottom of the central rear face of grille 8 has a substantially larger opening 86 than the other openings 88 in the grille. Opening 86 is more than twice as high as all the other openings 88 and extends substantially all the way across the width of the rear face of grille 8. As the screen cleaner of this invention works, it clears chaff and other debris off the screen with such cleared debris falling off of screen 6 or to the bottom of screen 6. Over time, some of this debris may build up on the exterior face of the bottom of screen 6. The larger opening 86 positioned adjacent the exterior face of the bottom of screen 6 allows the user to more easily reach his or her hand through such larger opening 86 to pull or clean any such built up or accumulated debris from the bottom of screen 6.

Various modifications of this invention will be apparent to those skilled in the art. For example, while screen cleaner 20, 20′ is preferably spaced from screen 6, 6′, some contact between the screen cleaner and screen could be permitted. Moreover, other types of powered actuators could be used to oscillate the screen cleaner, including actuators that convert a unidirectionally rotating input into an oscillating output. Accordingly, this invention is to be limited only the by the appended claims.

I claim:

1. A cleaner for a screen in a cooling system of an outdoor power equipment unit, which comprises:
(a) a cleaning member mounted for pivotal motion adjacent the screen, wherein the cleaning member is sized to cover a portion of the screen while leaving uncovered other portions of the screen; and
(b) a powered actuator for oscillating the cleaning member back and forth over the screen during operation of the outdoor power equipment unit such that the portion of the screen covered by the cleaning member varies during movement of the cleaning member as the cleaning member traverses over the screen, whereby airborne debris drops off the portion of the screen covered by the cleaning member to help keep the screen from becoming covered with airborne debris.

2. The cleaner of claim 1, wherein the screen is slanted from top to bottom such that the airborne debris that drops off the screen falls clear of any underlying lower portions of the screen.

3. The cleaner of claim 2, wherein the cleaning member is angled similarly to the screen to be substantially parallel to the screen.

4. The cleaner of claim 1, further including a guide between the cleaning member and a frame of the outdoor power equipment unit for guiding the cleaning member during its oscillating motion.

5. The cleaner of claim 4, wherein the guide comprises:
(a) a guide channel formed on the frame of the outdoor power equipment unit adjacent an air ingress opening covered by the screen; and
(b) a lip on the cleaning member received in the guide channel.

6. The cleaner of claim 1, wherein the cleaning member is spaced out of contact with the screen during its oscillating motion.

7. The cleaner of claim 1, wherein the portion of the screen traversed by the cleaning member is relatively flat.

8. The cleaner of claim 1, wherein the powered actuator has a reversible motion to oscillate the cleaning member.

9. The cleaner of claim 8, wherein the powered actuator comprises a linear actuator having a piston rod that can be extended from and retracted into a housing to create the reversible motion of the actuator, the cleaning member being pivotally connected to the piston rod of the linear actuator.

10. The cleaner of claim 8, wherein the powered actuator comprises a motor having a rotary motor shaft with a reversible direction of rotation to create the reversible motion of the actuator, the cleaning member being operatively connected to the reversible motor shaft.

11. The cleaner of claim 8, wherein the powered actuator is electrically powered.

12. The cleaner of claim 1, wherein the cleaning member comprises a plate.

13. An outdoor power equipment unit, which comprises:
(a) a movable frame carrying an implement for performing a ground or turf working or grooming operation;
(b) a prime mover carried on the frame;
(c) a cooling system carried on the frame for cooling the prime mover, the cooling system having a screen through which an air flow passes, the screen being slanted inwardly relative to the frame as the screen extends downwardly from top to bottom such that any airborne debris clinging to the screen can fall off the screen free of underlying portions of the screen over any portions of the screen through which air flow is momentarily blocked; and
(d) a movable cleaning member that momentarily blocks air flow through different and varying portions of the screen during operation of the outdoor power equipment unit.

14. The outdoor power equipment unit of claim 13, wherein the screen covers an air ingress opening, and wherein the cleaning member is pivotally mounted for oscillating movement back and forth over at least a portion of the screen covering the air ingress opening.

15. The outdoor power equipment unit of claim 13, further including a powered actuator for oscillating the cleaning member back and forth in a cyclic fashion over the screen.

16. The outdoor power equipment unit of claim 13, wherein the implement comprises at least one cutter for mowing grass.

17. The outdoor power equipment unit of claim 13, further including a grille adjacent the screen with the grille having a rear face adjacent the screen and sides that wrap around side edges of the screen.

18. The outdoor power equipment unit of claim 17, further including a pair of side baffles located inside the sides of the grille and adjacent the side edges of the screen for forcing the air flow to enter the screen generally perpendicularly.

19. The outdoor power equipment unit of claim 17, further including a bottom baffle adjacent a bottom edge of the screen covering a bottom of the grille behind the rear face and inwardly of the sides of the grille for blocking hot engine compartment air and for forcing the air flow to enter the screen generally perpendicularly.

20. The outdoor power equipment unit of claim 13, further including a grille adjacent the screen with the grille having a plurality of vertically spaced openings from top to bottom to allow air flow to pass through the openings, and wherein a lowermost grille opening is substantially larger in height than the grille openings above the lowermost opening to allow a user to reach through the lowermost grille opening and clean built up debris off a bottom portion of the screen.
